(19) United States
(12) Patent Application Publication
(10) Pub. No.: US 2009/0077979 A1
(43) Pub. Date: Mar. 26, 2009

(54) RESIDUAL STEAM REMOVAL MECHANISM AND RESIDUAL STEAM REMOVAL METHOD FOR STEAM COOLING PIPING OF GAS TURBINE

(75) Inventor: Morihiko Masaki, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/913,145

(22) PCT Filed: Nov. 30, 2006
(86) PCT No.: PCT/JP2006/323951

§ 371 Date: Oct. 30, 2007

(30) Foreign Application Priority Data
Dec. 7, 2005 (JP) 2005-352832

(51) Int. Cl. F02C 7/16

(52) U.S. Cl. 60/806; 60/39.15; 60/772; 415/114

(57) ABSTRACT

A combustor 10 is furnished with steam cooling piping 11. Steam is flowed by the following route, steam supply piping 20→steam cooling piping 11→steam discharge piping 70, to cool the combustor 10 with steam. When a gas turbine is stopped, valves V73, V71, V51, etc. are closed to construct a closed piping line composed of the pipings 20, 11 and 70. Then, the valve V71 is opened for evacuation by a condenser 90. Then, the valve V71 is closed, and the valve V51 is opened to charge nitrogen into the pipings 20, 11, 70. Then, the valve V51 is closed. By this procedure, residual steam within the steam cooling piping 11 can be reliably removed, and replaced by nitrogen. Thus, during stoppage of the gas turbine, residual steam can be removed reliably and promptly.

### TECHNICAL FIELD

This invention relates to a residual steam removal mechanism and a residual steam removal method for steam cooling piping of a gas turbine.

### BACKGROUND ART

In a combined cycle plant, the energy of a high temperature, high pressure exhaust gas discharged from a gas turbine is recovered by a waste heat boiler. High temperature, high pressure steam is generated by the recovered heat, and a steam turbine is rotated by this steam.

Cooling of a combustor of the gas turbine has hitherto been performed using air. That is, part of air compressed by a compressor of the gas turbine has been used as a cooling medium for cooling the combustor.

In recent year, however, steam, which has a greater heat capacity and a higher cooling ability than air, has been used as a cooling medium for the combustor instead of air. Concretely, steam is extracted from an intermediate pressure drum of the waste heat boiler, and this steam is guided to the combustor to carry out cooling.

By using steam as the cooling medium for the combustor instead of air, as mentioned above, all of air compressed by the compressor can be used for combustion. Thus, the inlet temperature of the gas turbine can be raised, thereby resulting in an increased efficiency.

If steam is used as the cooling medium for the combustor, as noted above, steam remaining in a steam cooling line for cooling the combustor has to be discharged to the outside, when the gas turbine is stopped, to prevent condensate from remaining in the steam cooling line, or prevent rust due to the condensate from forming.

When the gas turbine has been stopped, therefore, it has been common practice to flow control air (or house air) through the steam cooling line continuously, thereby discharging the steam remaining inside.

The conventional steam cooling line for cooling the combustor of the gas turbine with steam, and the conventional residual steam discharge method will now be described with reference to FIG. 2.

A transition pipe of a combustor 10 of a gas turbine is furnished with steam cooling piping 11 for cooling the transition pipe. In FIG. 2, the steam cooling piping 11 is schematically drawn, but actually, the steam cooling piping 11 is composed of many ramified piping groups, and this piping includes thin portions and sharply curved portions.

Drain piping 12 having a valve V12 interposed therein is connected to the steam cooling piping 11.

The leading end of steam supply piping 20 is connected to an inlet portion of the steam cooling piping 11 (in FIG. 2, a portion a). Drain piping 21 having a valve V21 interposed therein, and drain piping 22 having a valve V22 interposed therein are connected to halfway portions of the steam supply piping 20 (in FIG. 2, portions b and c).

Further, auxiliary steam piping 30, main steam piping 40, and gas piping 50 are connected to base end portions of the steam supply piping 20 (in FIG. 2, portions d, e and f).

Drain piping 31 having a valve V31 interposed therein is connected to a halfway portion of the auxiliary steam piping 30. Valves V32, V33 and V34 are interposed in the auxiliary steam piping 30. The auxiliary steam piping 30 is supplied with steam from an auxiliary steam source (not shown).

Drain piping 41 having a valve V41 interposed therein is connected to a halfway portion of the main steam piping 40. A valve V42 is interposed in the main steam piping 40. The main steam piping 40 is supplied with steam from an intermediate pressure drum of a waste heat boiler 60.

A valve V51 and a check valve V52 are interposed in the gas piping 50. The gas piping 50 is supplied with air from a control air source (house air source; not shown) by opening the valve V51.

The base end of steam discharge piping 70 is connected to an outlet portion of the steam cooling piping 11 (in FIG. 2, a portion g). Drain piping 71 having a valve V71 interposed therein, and drain piping (start-up relief line) 72 having a valve V72 interposed therein are connected to halfway portions of the steam discharge piping 70. Also, a valve V73 and a valve V74 are provided halfway through the steam discharge piping 70.

The drain piping 71 becomes open to the atmosphere when the valve V71 is opened. The drain piping (start-up relief line) 72 is connected to a condenser 90 when the valve V72 is opened. The steam discharge piping 70 is connected to a steam turbine when the valve V74 is opened.

Next, an explanation will be offered for an operating state when the transition pipe of the combustor 10 is cooled with steam by the conventional steam cooling line having the above-described features. At this time, the valves V12, V21, V22, V31, V41, V71 and V72 interposed in the drain pipings 12, 21, 22, 31, 41, 71 and 72, respectively, are rendered closed.

At start-up, the valves V32, V33 and V34 interposed in the steam supply piping 30 are opened, while the valve V42 interposed in the main steam piping 40 is closed, so that steam from the auxiliary steam source (not shown) is supplied into the steam supply piping 20.

By so doing, steam fed from the auxiliary steam source, passed through the auxiliary steam piping 30, and supplied to the steam supply piping 20 is flowed by the following route, steam supply piping 20→steam cooling piping 11→steam discharge piping 70, passed through the valve V74, and fed to the steam turbine, as indicated by a dashed arrow in FIG. 2.

As noted above, steam flows through the steam cooling piping 11 provided in the transition pipe of the combustor 10, whereby cooling of the transition pipe of the combustor 10 can be performed.

When steam generated in the waste heat boiler 60 has exceeded a predetermined pressure and a predetermined temperature, steam from the intermediate pressure drum of the waste heat boiler 60 is supplied to the steam supply piping 20. For this purpose, the valve V42 interposed in the main steam piping 40 is opened, and the valves V32, V33 and V34 interposed in the steam supply piping 30 are closed.

By so doing, steam fed from the intermediate pressure drum of the waste heat boiler 60, passed through the main steam piping 40, and supplied to the steam supply piping 20 is flowed by the following route, steam supply piping 20→steam cooling piping 11→steam discharge piping 70, passed through the valve V74, and fed to the steam turbine, as indicated by the dashed arrow in FIG. 2.

As noted above, steam flows through the steam cooling piping 11 provided in the transition pipe of the combustor 10, whereby cooling of the transition pipe of the combustor 10 can be performed.

Next, an explanation will be offered for actions performed when stopping the gas turbine and carrying out purging so that no condensate will remain in the steam cooling piping 11.

At this time, the valves V12, V21, V22, V31, V41, and V72 interposed in the drain pipings 12, 21, 22, 31, 41 and 72, respectively, are closed, while the valve V71 interposed in the drain piping 71 is opened.

Furthermore, the valve V34 interposed in the auxiliary steam piping 30 is closed, the valve V42 interposed in the main steam piping 40 is closed, and the valve V73 interposed in the steam discharge piping 70 are closed.

Besides, the valve V51 interposed in the gas piping 50 is opened to supply air from the control air source (house air source) to the gas piping 50.

By so doing, air fed from the control air source, passed through the gas piping 50, and supplied to the steam supply piping 20 is flowed by the following route, steam supply piping 20→steam cooling piping 11→steam discharge piping 70, further passed through the drain piping 71, and discharged into the atmosphere, as indicated by a dashed double-dotted arrow in FIG. 2. On this occasion, air is flowed continuously (for example, for 30 minutes or so).

In this manner, air continuously flows through the steam cooling piping 11 provided in the combustor 10, whereby steam remaining in the steam cooling piping 11 provided in the combustor 10 is pushed outside (purged). This contrivance has prevented condensate from remaining in the steam cooling piping 11, or has prevented rust from forming because of the remaining condensate.

Patent Document 1: Japanese Unexamined Patent Publication No. 2002-147205

Patent Document 2 Japanese Unexamined Patent Publication No. 2003-293707

### DISCLOSURE OF THE INVENTION

### Problems to be Solved by the Invention

With the above-described conventional technologies, air is flowed continuously (for example, for 30 minutes) when purging is performed, thus requiring a large amount of control air. Control air is used as a source of various actions within the plant. Since it is used for purging, a burden is imposed on the actions of other instruments which use the control air source as an operating source. Thus, it has been necessary to increase the capacity of the control air source sufficiently greatly.

Moreover, air is continuously flowed, but flows with difficulty in thin portions and sharply curved portions of the steam cooling piping 11. This has aroused concern that residual steam in such portions may not be completely pushed out.

If air and steam dwell in the steam cooling piping 11 and condensate accumulates there, a risk due to rust as a risk factor increases. Rust may cause clogging of the cooling steam fin of the transition pipe. Thus, such an event poses a serious problem.

Furthermore, air is used as a gas for expelling steam (a purging gas). However, there has been concern that air tends to react with condensate to cause rust formation.

Recently, it has become common practice to carry out cooling by arranging steam cooling piping not only in the combustor of the gas turbine, but also in the blades of the gas turbine.

The provision of the steam cooling piping in the blades of the gas turbine has posed the same problem as when the steam cooling piping is provided in the combustor.

The present invention has been accomplished in the light of the above-described conventional technologies. It is an object of the invention to provide a residual steam removal mechanism and a residual steam removal method for steam cooling piping of a gas turbine, capable of purging steam, which has remained in steam cooling piping provided in a member of a gas turbine to be cooled (i.e., a combustor or a blade), with a smaller amount of a gas (air or nitrogen) than conventionally, and performing such purging in a short time.

### Means for Solving the Problems

The residual steam removal mechanism for steam cooling piping of a gas turbine according to the present invention, for solving the above problems, is a residual steam removal mechanism for steam cooling piping of a gas turbine, comprising:

the steam cooling piping provided in a member, to be cooled, of the gas turbine of a combined cycle plant;

steam supply piping, connected to an inlet portion of the steam cooling piping, for supplying steam to the steam cooling piping;

steam discharge piping, connected to an outlet portion of the steam cooling piping, for discharging steam which has passed through the steam cooling piping, the steam discharge piping having a valve interposed halfway therein;

gas piping having a base end thereof connected to a gas source, having a leading end thereof connected to the steam supply piping, and further having a valve interposed halfway therein;

drain piping having a base end thereof connected to a position between a portion of the steam discharge piping connected to the steam cooling piping and the valve interposed in the steam discharge piping, the drain piping having a leading end thereof connected to a condenser and also having a valve interposed halfway therein;

various pipings having valves interposed therein, and being connected to the steam supply piping or the steam cooling piping; and

a control section for exercising opening and closing control of the valves, and

wherein the control section exercises the opening and closing control in such a manner as to

first close the valve interposed in the steam discharge piping, the valve interposed in the gas piping, the valve interposed in the drain piping, and the valves interposed in the various pipings,

then open and then close again the valve interposed in the drain piping, and

then open and then close again the valve interposed in the gas piping.

The residual steam removal method for steam cooling piping of a gas turbine according to the present invention is a residual steam removal method for steam cooling piping of a gas turbine, comprising the steps of:

converting a piping line into a closed piping line by closing a valve interposed in the piping line and valves interposed in pipings connected to the piping line, the piping line comprising the steam cooling piping provided in a member, to be cooled, of the gas turbine of a combined cycle plant, steam supply piping for supplying steam to the steam cooling piping, and steam discharge piping for discharging steam which has passed through the steam cooling piping;

connecting the closed piping line to a condenser to evacuate internal spaces of the steam cooling piping, the steam supply piping, and the steam discharge piping constituting the closed piping line, and cutting off connection with the condenser after evacuation to return the steam cooling piping, the steam supply piping, and the steam discharge piping to the closed piping line; and

filling a gas into the evacuated internal spaces of the steam cooling piping, the steam supply piping, and the steam discharge piping.

The present invention is also characterized in that

a gas supplied from the gas source is nitrogen, or

a gas supplied from the gas source is air, or

the member to be cooled is a combustor of the gas turbine, or

the member to be cooled is a blade of the gas turbine.

### EFFECTS OF THE INVENTION

According to the present invention, when purging is performed, opening and closing control of the valves is effected, whereby the steam cooling piping, the steam supply piping, and the steam discharge piping are converted into the closed piping line. This closed piping line is connected to the condenser placed in a vacuum state, and is evacuated thereby. Thus, removal of residual steam to the outside can be performed reliably in a short time.

The closed piping line is supplied with nitrogen or air, whereby nitrogen (or air) can be charged into it as a replacement for residual steam. Thus, residual steam can be removed reliably, and the amount of nitrogen (or air) supplied can be reduced as compared with that in the conventional technology.

### BRIEF DESCRIPTION OF THE DRAWINGS

FIG. 1 is a configurational drawing showing a residual steam removal mechanism for steam cooling piping of a gas turbine according to Embodiment 1 of the present invention.

FIG. 2 is a configurational drawing showing a residual steam removal mechanism for steam cooling piping of a gas turbine according to a conventional technology.

### DESCRIPTION OF THE REFERENCE NUMERALS

10 Combustor
11 Steam cooling piping
20 Steam supply piping
30 Auxiliary steam piping
40 Main steam piping
50 Gas piping
60 Waste heat boiler
70 Steam discharge piping
80 Nitrogen source
90 Condenser
100 Control section

### BEST MODE FOR CARRYING OUT THE INVENTION

The best mode for carrying out the present invention will now be described in detail based on the accompanying drawings.

### Embodiment 1

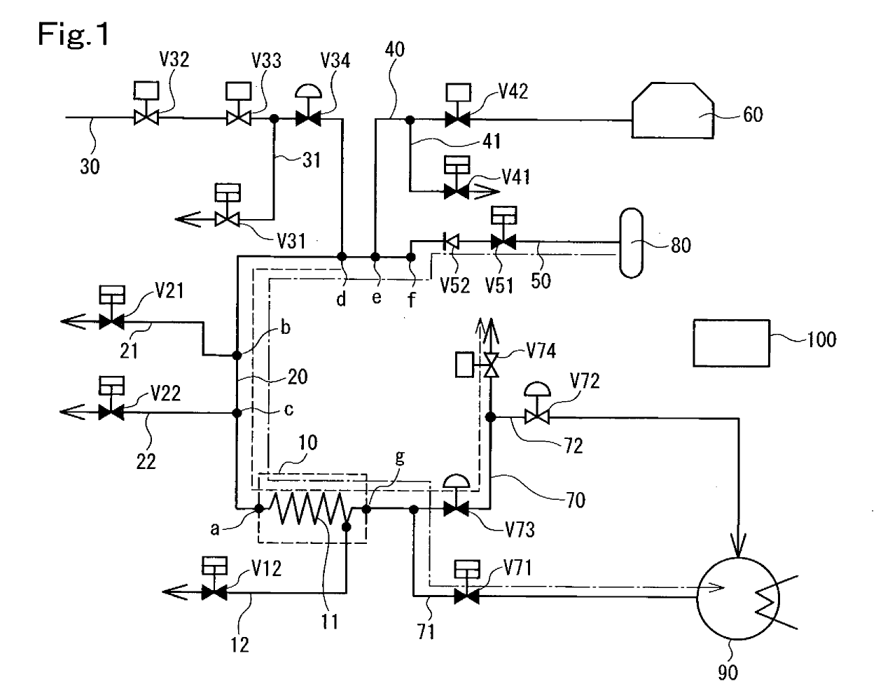

FIG. 1 shows a mechanism according to Embodiment 1 for removing steam remaining in steam cooling piping provided in a combustor of a gas turbine.

The present embodiment is predicated on a combined cycle plant, and has been applied to a plant equipped with a gas turbine, a steam turbine, a waste heat boiler, and a condenser.

As shown in the drawing, the leading end of drain piping 71 is connected to a condenser 90. The condenser 90 is subject to a vapor-liquid volume change, with which steam condenses, and is also evacuated by a vacuum pump (not shown). Thus, the internal space of the condenser 90 is in a high vacuum.

The base end of the drain piping 71 is connected to a portion intermediate between the base end of steam discharge piping 70 (in FIG. 1, a portion g) and a site where a valve V73 is interposed.

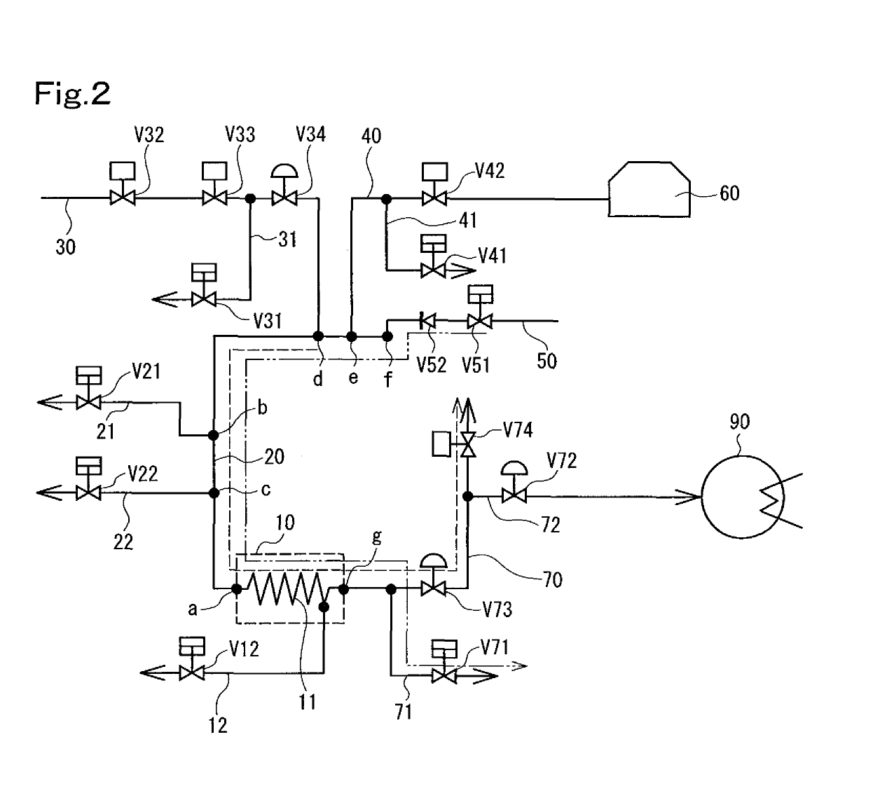

Incidentally, according to the conventional technology shown in FIG. 2, the leading end of the drain piping 71 has been opened to the atmosphere.

A nitrogen source 80 is connected to the base end of gas piping 50, and the leading end of the gas piping 50 is connected to the base end of steam supply piping 20.

Further, a control section 100 is provided for performing the opening and closing of the valves shown in FIG. 1 by sequential control.

The features of other portions are the same as those in the conventional technology shown in FIG. 2. Thus, the same portions are assigned the same numerals, and duplicate explanations are omitted.

Moreover, the procedure for passing steam through steam cooling piping 11 provided in a transition pipe of a combustor 10 to cool the transition pipe of the combustor 10 is also the same as the conventional procedure. Thus, its explanation is omitted.

Next, an explanation will be offered for actions performed when stopping the gas turbine and carrying out purging so that no condensate will remain in the steam cooling piping 11. These actions are performed, with the valves being controlled to be opened and closed, and this opening and closing control over the valves is exercised through control of the control section 100. The control section 100 performs opening and closing control over the valves in the manner described below to carry out purging:

(1) First, the steam supply piping 20, the steam cooling piping 11, and a piping portion on the base end side of the steam discharge piping 70 (in FIG. 1, the piping portion between the portion g and the site where the valve V73 is interposed) are closed to construct a closed piping line.

Concretely, the valves filled in with black in FIG. 1 are closed. That is,

(a) a valve V12 interposed in drain piping 12 connected to the steam cooling piping 11 is closed,
(b) valves V21, V22, V34, V42, V41 and V51 interposed in pipings 21, 22, 30, 40, 41 and 50 connected to the steam supply piping 20 are closed, and
(c) the valve V73 interposed in the steam discharge piping 70 is closed, and a valve V71 interposed in the drain piping 71 connected to the steam discharge piping 70 is closed.
(2) Then, the closed valve V71 is opened. By this motion, steam remaining in the steam supply piping 20, the steam cooling piping 11, and the piping portion on the base end side of the steam discharge piping 70, which constitute the closed piping line, is evacuated by the condenser 90. As a result, the internal space of the steam supply piping 20, the internal space of the steam cooling piping 11, and the internal space of the piping portion on the base end side of the steam discharge piping 70 are brought into a vacuum state, and steam is reliably discharged from them. Because of such evacuation, discharge of the residual steam can be performed reliably in a short time.

After the closed piping line (the internal spaces of the pipings 10, 20 and the internal space on the base end side of the piping 70) is evacuated in the above manner to create a vacuum, the valve V71 is closed.

(3) Then, the valve V51 interposed in the gas piping 50 is brought from the closed state to an open state. By this motion, nitrogen is flowed from the nitrogen source 80, passed through the gas piping 50, and supplied into (charged into) the internal space of the steam supply piping 20, the internal space of the steam cooling piping 11, and the internal space of the piping portion on the base end side of the steam discharge piping 70. When the nitrogen pressure inside the pipings 20, 11 and 70 reaches a predetermined pressure (for example, 0.05 MPa), the valve V51 is closed to stop the supply of nitrogen. The supply of nitrogen may be stopped at a time when nitrogen fills the interiors of the pipings 20, 11 and 70 to reach the predetermined pressure. Thus, the supply time for nitrogen is short (e.g., several minutes), and the amount of nitrogen supply may be very small compared with the amount of air supply in the conventional technology.

As noted above, steam remaining in the internal space of the steam cooling piping 11 provided in the combustor 10, the internal space of the steam supply piping 20, and the internal space on the base end side of the steam discharge piping 70 is completely removed (evacuated), and then nitrogen is fed as a replacement. As a result, there is no risk of condensate remaining in the steam cooling piping 11. Moreover, replacement with nitrogen can reliably prevent rust formation.

Furthermore, removal of residual steam can be performed in a short time, and charging with nitrogen can be carried out in a short time. Thus, the operating time for purging is short.

Besides, after the above processings (1) to (3) are performed, the processings (2) and (3) may be performed again to evacuate the initially charged nitrogen and, after this evacuation, charge nitrogen again. By this procedure, discharge of residual steam, prevention of condensate formation, and prevention of rust formation can be performed more reliably.

### Embodiment 2

In Embodiment 1 shown in FIG. 1, the nitrogen source 80 is connected to the base end of the gas piping 50. However, a control air source may be connected to the base end of the gas piping 50. After the closed piping line (the internal spaces of the pipings 10, and the internal space on the base end side of the piping 70) is evacuated by use of the condenser 90 to create a vacuum, air may be supplied from the control air source, and air may be charged into the closed piping line.

If such a procedure is performed, it suffices to supply (charge) control air in an amount corresponding to the capacity of the closed piping line. Thus, the amount of air used is extremely small compared with that in the conventional technology.

### Embodiment 3

According to the aforementioned conventional technology, the steam cooling piping is provided in the combustor. Even when the steam cooling piping is disposed in the blade of the gas turbine, the present invention can be applied.

1. A residual steam removal mechanism for steam cooling piping of a gas turbine, comprising:
the steam cooling piping provided in a member, to be cooled, of the gas turbine of a combined cycle plant;
steam supply piping, connected to an inlet portion of the steam cooling piping, for supplying steam to the steam cooling piping;
steam discharge piping, connected to an outlet portion of the steam cooling piping, for discharging steam which has passed through the steam cooling piping, the steam discharge piping having a valve interposed halfway therein;
gas piping having a base end thereof connected to a gas source, having a leading end thereof connected to the steam supply piping, and further having a valve interposed halfway therein;
drain piping having a base end thereof connected to a position between a portion of the steam discharge piping connected to the steam cooling piping and the valve interposed in the steam discharge piping, the drain piping having a leading end thereof connected to a condenser and also having a valve interposed halfway therein;
various pipings having valves interposed therein, and being connected to the steam supply piping or the steam cooling piping; and
a control section for exercising opening and closing control of the valves, and
wherein the control section exercises the opening and closing control in such a manner as to
first close the valve interposed in the steam discharge piping, the valve interposed in the gas piping, the valve interposed in the drain piping, and the valves interposed in the various pipings,
then open and then close again the valve interposed in the drain piping, and
then open and then close again the valve interposed in the gas piping.

2. The residual steam removal mechanism for steam cooling piping of a gas turbine according to claim 1, characterized in that the gas source is a nitrogen source for supplying nitrogen.

3. The residual steam removal mechanism for steam cooling piping of a gas turbine according to claim 1, characterized in that the gas source is an air source for supplying air.

4. The residual steam removal mechanism for steam cooling piping of a gas turbine according to any one of claims 1 to 3, characterized in that the member to be cooled is a combustor of the gas turbine.

5. The residual steam removal mechanism for steam cooling piping of a gas turbine according to any one of claims 1 to 3, characterized in that the member to be cooled is a blade of the gas turbine.

6. A residual steam removal method for steam cooling piping of a gas turbine, comprising the steps of:
converting a piping line into a closed piping line by closing a valve interposed in the piping line and valves interposed in pipings connected to the piping line, the piping line comprising the steam cooling piping provided in a member, to be cooled, of the gas turbine of a combined cycle plant, steam supply piping for supplying steam to the steam cooling piping, and steam discharge piping for discharging steam which has passed through the steam cooling piping;
connecting the closed piping line to a condenser to evacuate internal spaces of the steam cooling piping, the steam supply piping, and the steam discharge piping constituting the closed piping line, and cutting off connection with the condenser after evacuation to return the steam cooling piping, the steam supply piping, and the steam discharge piping to the closed piping line; and
filling a gas into the evacuated internal spaces of the steam cooling piping, the steam supply piping, and the steam discharge piping.

7. The residual steam removal method for steam cooling piping of a gas turbine according to claim 6, characterized in that the gas is nitrogen.

8. The residual steam removal method for steam cooling piping of a gas turbine according to claim 7, characterized in that the gas is air.

9. The residual steam removal method for steam cooling piping of a gas turbine according to any one of claims 6 to 8, characterized in that the member to be cooled is a combustor of the gas turbine.

10. The residual steam removal method for steam cooling piping of a gas turbine according to any one of claims 6 to 8, characterized in that the member to be cooled is a blade of the gas turbine.
